(19) United States
(12) Patent Application Publication
(10) Pub. No.: US 2025/0255214 A1
(43) Pub. Date: Aug. 14, 2025

(54) CUTTER HOLDER FOR FACILITATING PLANT MATERIAL CUTTING

(71) Applicant: PRO MAC EQUIPMENT LTD., Duncan (CA)

(72) Inventors: Gary David POWERS, Duncan, British Columbia (CA); Kyle Warren GOODWIN, Duncan, British Columbia (CA)

(21) Appl. No.: 18/850,017

(22) PCT Filed: Feb. 24, 2023
(86) PCT No.: PCT/CA2023/050237

§ 371 Date: Sep. 23, 2024

Related U.S. Application Data
(60) Provisional application No. 63/326,038, filed on Mar. 31, 2022.

(51) Int. Cl. A01D 34/44; A01D 34/52

(52) U.S. Cl. CPC A01D 34/44; A01D 34/52

(57) ABSTRACT

A cutter holder for facilitating plant material cutting includes a base configured to rotationally couple to a driver and to rotate about an axis of rotation of the base during operation, one or more cutter mounts coupled to the base, each of the one or more cutter mounts configured to hold a respective cutter and to facilitate cutting of plant material by the cutter when the cutter is held and the base is rotated about the axis of rotation by the driver, a first coupler coupled to the base, and, a second coupler coupled to the base, the second coupler axially spaced from the first coupler and configured to rotationally couple to a first coupler of a further cutter holder. Other apparatuses, systems, and methods are disclosed.

### CROSS REFERENCES

This application claims the benefit of U.S. provisional patent application No. 63/326,038 entitled “CUTTER HOLDER FOR FACILITATING PLANT MATERIAL CUTTING”, filed on Mar. 31, 2022, which is hereby incorporated by reference herein in its entirety.

### BACKGROUND

### 1. Field

Embodiments of this disclosure relate to plant material cutting and more particularly to facilitating plant material cutting with at least one cutter holder.

### 2. Description of Related Art

Some known mulching arbor devices may use teeth or tooth holders welded to the outside of a single rotatable drum. Such devices may require extensive machining, fabrication and welding to manufacture. Further, such devices may be difficult and/or costly to maintain, such as, for example, when damage occurs.

### SUMMARY

In accordance with various embodiments, there is provided a cutter holder for facilitating plant material cutting, the cutter holder including a base configured to rotationally couple to a driver and to rotate about an axis of rotation of the base during operation, one or more cutter mounts coupled to the base, each of the one or more cutter mounts configured to hold a respective cutter and to facilitate cutting of plant material by the cutter when the cutter is held and the base is rotated about the axis of rotation by the driver, a first coupler coupled to the base, and, a second coupler coupled to the base, the second coupler axially spaced from the first coupler and configured to rotationally couple to a first coupler of a further cutter holder.

Each of the one or more cutter mounts may include an integral mount portion integral with the base and disposed radially outward from the base.

The integral mount portion of each of the one or more cutter mounts may include a cutter engaging face configured to abut a cutter when the cutter is held by the cutter mount, the cutter engaging face generally perpendicular to a direction of travel of the cutter engaging face when the base is rotated about the axis of rotation.

The integral mount portion of each of the one or more cutter mounts may include a bite limiter.

The integral mount portion may include a cutter mount body, the bite limiter extending from the cutter mount body and axially narrower than the cutter mount body.

The first and second couplers may be integral with the base.

The base may include a ring configured to engage and encircle a drive shaft configured to be driven by the driver.

The base may include at least one convex outer surface portion disposed radially inward of the one or more cutter mounts.

The at least one convex outer surface portion may include one or more cylindrical surface portions centered on the axis of rotation.

The one or more cutter mounts may include a plurality of cutter mounts each of the plurality of cutter mounts configured to hold a respective cutter.

The one or more cutter mounts may include a first cutter mount and a second cutter mount, the second cutter mount angularly displaced from the first cutter mount by about 180 degrees about the axis of rotation.

The second coupler may be configured to removably couple to the first coupler of the further cutter holder.

The first coupler may include at least one first coupler face that extends radially from and parallel to the axis of rotation and the second coupler includes at least one second coupler face that extends radially from and parallel to the axis of rotation such that at least one second coupler face is configured to engage at least one first coupling face of the further cutter holder to rotationally couple to the first coupler of the further cutter holder.

The first coupler may include three protrusions extending axially and the second coupler may include three protrusions extending axially.

Each of the one or more cutter mounts may be configured to releasably hold the respective cutter.

In accordance with various embodiments, there is provided an apparatus for facilitating plant material cutting, the apparatus including a first cutter holder according to the above and a second cutter holder according to the above, the first coupler of the second cutter holder coupled to the second coupler of the first cutter holder to rotationally couple the first and second cutter holders.

The first coupler of the second cutter holder may be coupled to the second coupler of the first cutter holder such that the first cutter holder is rotationally offset from the second cutter holder by a first offset angle.

The apparatus may include a third cutter holder according to the above, the first coupler of the third cutter holder coupled to the second coupler of the second cutter holder to rotationally couple the first, second, and third cutter holders such that the first cutter holder is rotationally offset from the third cutter holder by a second offset angle.

In accordance with various embodiments, there is provided a system for facilitating plant material cutting, the system including the apparatus including the first and second cutter holders according to the above, each of the cutter mounts of the cutter holders of the apparatus holding a respective one of the plurality of cutters.

The system may include a driver coupled to the bases of the cutter holders of the apparatus, the driver configured to rotate the cutter holders and the plurality of cutters to cause the cutters to cut plant material.

In accordance with various embodiments, there is provided a method of manufacturing a cutter holder for facilitating plant material cutting, the method including machining a single integral workpiece of material by removal of material to produce the cutter holder described above.

In accordance with various embodiments, there is provided a system for manufacturing a cutter holder for facilitating plant material cutting, the system comprising a milling machine configured to perform the above method of manufacturing a cutter holder.

In accordance with various embodiments, there is provided a method of manufacturing a cutter holder for facilitating plant material cutting, the method comprising casting the cutter holder described above.

In accordance with various embodiments, there is provided a method of manufacturing a cutter holder for facilitating plant material cutting, the method comprising forging the cutter holder described above

Other aspects and features of embodiments of the present disclosure will become apparent to those ordinarily skilled in the art upon review of the following description of specific embodiments of the present disclosure in conjunction with the accompanying figures.

### BRIEF DESCRIPTION OF THE DRAWINGS

In drawings which illustrate embodiments of the present disclosure,

FIG. 1 is a first perspective view of a first cutter holder for facilitating plant material cutting, according to various embodiments;

FIG. 2 is a second perspective view of a first cutter holder for facilitating plant material cutting, according to various embodiments;

FIG. 3 is a perspective view of an apparatus for facilitating plant material cutting, including the first cutter holder shown in FIGS. 1 and 2, according to various embodiments;

FIG. 4 is a side view of a system for facilitating plant material cutting, according to various embodiments, the system including the apparatus shown in FIG. 3;

FIG. 5 is a first perspective exploded view of the apparatus shown in FIG. 3, according to various embodiments;

FIG. 6 is a second perspective exploded view of the apparatus shown in FIG. 3, according to various embodiments;

FIG. 7 is an enlarged view of a portion of the apparatus shown in FIG. 5, according to various embodiments;

FIG. 8 is an enlarged view of a portion of the apparatus shown in FIG. 6, according to various embodiments;

FIG. 9 is an end view of the apparatus shown in FIG. 3, according to various embodiments;

FIG. 10 is a schematic view of a system for manufacturing the first cutter holder shown in FIGS. 1 and 2, according to various embodiments; and

FIG. 11 is a perspective view of a boom mountable system including the apparatus shown in FIG. 3, according to various embodiments;

### DETAILED DESCRIPTION

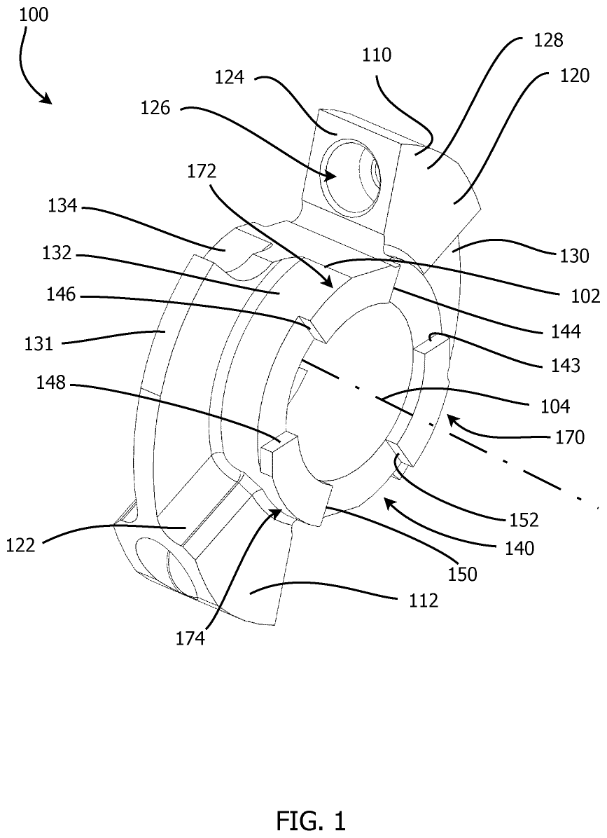

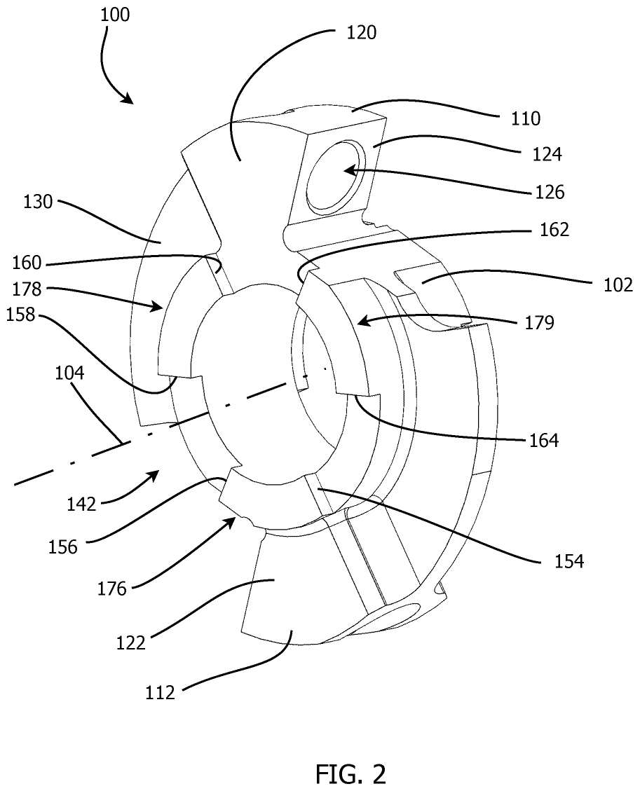

Referring to FIGS. 1 and 2, there is shown a first cutter holder 100 or apparatus for facilitating plant material cutting, according to various embodiments, from two different perspective views. In various embodiments, the first cutter holder 100 may facilitate plant material cutting or mulching using a modular system having replaceable elements, which may facilitate ease of manufacturing and/or maintenance resulting in reduced manufacturing and/or maintenance costs.

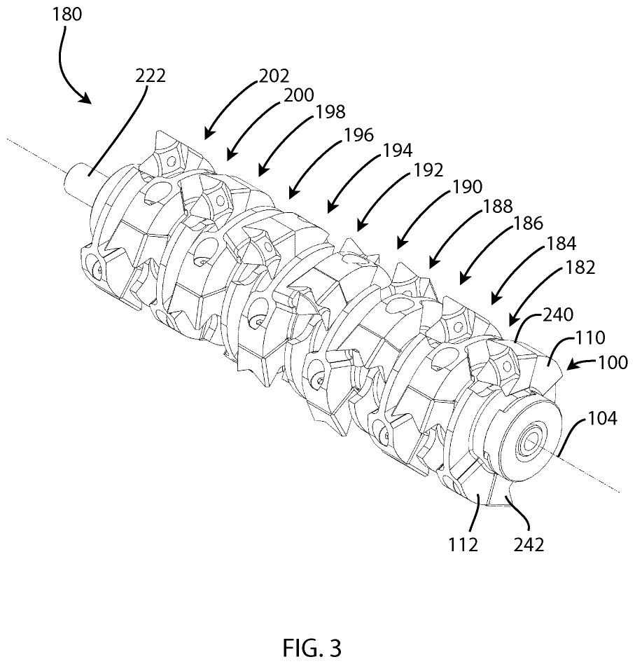

Referring to FIG. 3, there is shown an apparatus 180 for facilitating plant material cutting, the apparatus 180 including a plurality of cutter holders, including the first cutter holder 100 and a second cutter holder 182, coupled together. In some embodiments, the apparatus 180 may include a third cutter holder 184 and/or additional cutter holders. For example, in some embodiments, the apparatus 180 may include a fourth cutter holder 186, a fifth cutter holder 188, a sixth cutter holder 190, a seventh cutter holder 192, an eighth cutter holder 194, a ninth cutter holder 196, a tenth cutter holder 198, an eleventh cutter holder 200, and a twelfth cutter holder 202. In various embodiments, the apparatus 180 may include a plurality of cutters, each of the cutters held by one of the cutter holders. For example, in some embodiments, each of the cutter holders 100 and 182-202 may include two cutter mounts, each cutter mount configured to hold a cutter, and the apparatus 180 may include 24 cutters, each cutter coupled to a respective cutter mount of one of the cutter holders 100 and 182-202.

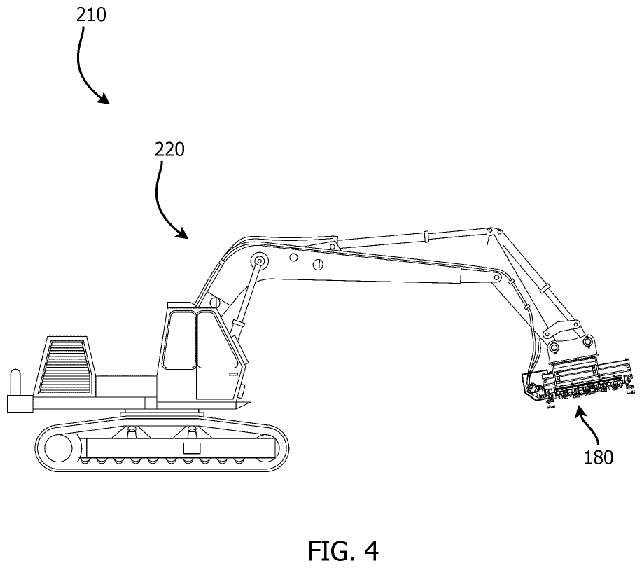

Referring to FIG. 4, there is shown a system 210 for facilitating plant material cutting, according to various embodiments, the system including the apparatus 180 and a driver 220 coupled to the apparatus 180. In various embodiments, the driver 220 may be configured to rotate the apparatus 180 to cause the cutter holders and the cutters thereon to cut plant material. In various embodiments, the modularity of the apparatus 180 as derived from features of the cutter holders 100 and 182-202 shown in FIG. 3 may facilitate plant material cutting or mulching while also facilitating ease of manufacturing and/or maintenance, which may result in reduced manufacturing and/or maintenance costs.

Referring back to FIGS. 1 and 2, the first cutter holder 100 will be described in detail. In various embodiments, the first cutter holder 100 may be exemplary and each of the cutter holders 182-202 included in the apparatus 180 shown in FIG. 3 may be generally the same as the first cutter holder 100.

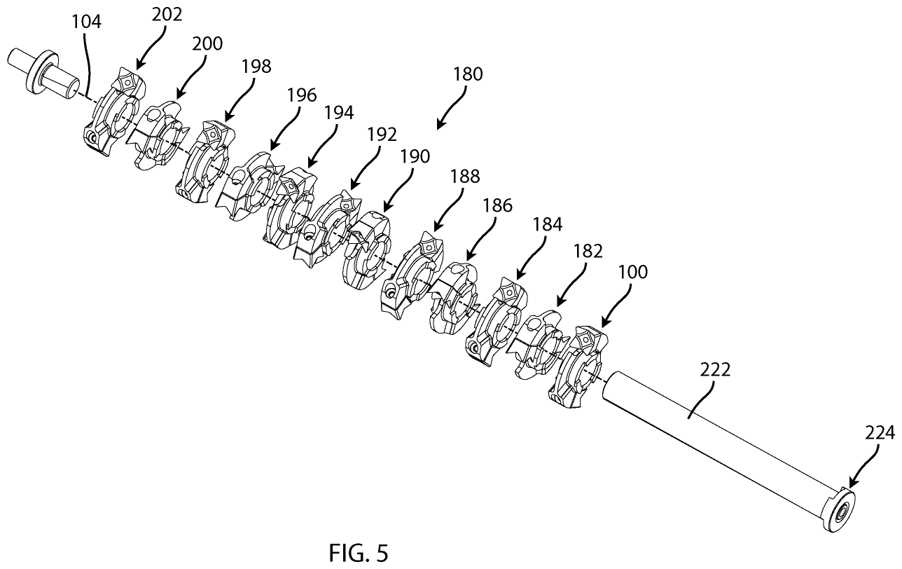

Referring to FIGS. 1 and 2, in various embodiments, the first cutter holder 100 may include a base 102 configured to rotationally couple to the driver (shown at 220 in FIG. 4) and to rotate about an axis of rotation 104 of the base during operation. In some embodiments, the base 102 may include a ring configured to engage and encircle a drive shaft (shown at 222 in FIGS. 3 and 5, for example) configured to be driven by the driver 220 shown in FIG. 4. In some embodiments, the base 102 including a ring configured to engage and encircle the drive shaft 222 may facilitate a strong connection between the base 102 and the driver 220, which may facilitate robust driving of the first cutter holder 100 by the driver 220 during operation. In various embodiments, the base 102 including a ring configured to engage and encircle the drive shaft 222 may facilitate reduced likelihood that the first cutter holder 100 may slip relative to or disengage with the other cutter holders of the apparatus 180 shown in FIG. 3. In various embodiments, the base 102 may include an inner surface that is generally cylindrical and centered around the axis of rotation 104.

Referring to FIGS. 1 and 2, in various embodiments, the first cutter holder 100 may include first and second cutter mounts 110 and 112 coupled to the base 102, each of the first and second cutter mounts 110 and 112 configured to hold a respective cutter and to facilitate cutting of plant material by the cutter when the cutter is held and the base 102 is rotated about the axis of rotation 104 by the driver. In various embodiments, including the cutter mounts 110 and 112 for holding cutters instead of cutters alone may facilitate the use of various cutters with the first cutter holder 100, including for example cutters that are made of different material compared to the cutter holder 100. In some embodiments, this may facilitate improved versatility, performance and/or manufacturing costs for the first cutter holder 100 and cutters held therein. In various embodiments, including the cutter mounts 110 and 112 may facilitate ease of manufacturing the cutter holder 100, such as by machining, casting, and/or forging, which may require materials having different strength and hardness properties compared to a cutter which may be held by the cutter mounts 110 and 112. In various embodiments, including the cutter mounts 110 and 112 for holding cutters may facilitate ease of maintenance of the first cutter holder 100 by facilitating replacement of cutters. In various embodiments, the first cutter holder 100 including more than one cutter mount may facilitate fast and/or efficient cutting of plant material. In various embodiments, the first and second cutter mounts 110 and 112 may be generally similar.

In various embodiments, the cutter mounts 110 and 112 may include integral mount portions 120 and 122, respectively, each of the integral mount portions 120 and 122 being integral with the base 102 and disposed radially outward from the base 102.

In various embodiments, the second cutter mount 112 may be angularly displaced from the first cutter mount 110 by about 180 degrees about the axis of rotation 104. In various embodiments, the first and second cutter mounts 110 and 112 being angularly offset by about 180 degrees may facilitate even spacing of the cutters on the cutter mounts 110 and 112, which may facilitate improved performance during cutting.

In various embodiments, the integral mount portion 120 may include a cutter engaging face 124 configured to abut a cutter when the cutter is held by the cutter mount 110, the cutter engaging face generally perpendicular to a direction of travel of the cutter engaging face when the base 102 is rotated about the axis of rotation 104. For example, in some embodiments, the cutter engaging face 124 may be angled inward toward the axis of rotation 104 by an angle of less than 10 degrees. In various embodiments, the cutter engaging face 124 may form an angle of between about 80-100 degrees with the direction of travel of the cutter engaging face. In various embodiments, the cutter engaging face 124 being generally perpendicular to the direction of travel of the cutter engaging face may facilitate a strong connection between the cutter engaging face 124 and a cutter engaged by the cutter engaging face 124, which may facilitate reduced damage and robust use of the first cutter holder 100 and cutters for high impact cutting.

In various embodiments, the integral mount portion 120 may include a mounting hole 126 for use with a fastener, such as a bolt, to rigidly hold a cutter against the cutter engaging face 124. In various embodiments, the integral mount portion 120 may include a cutter mount body 128 including the cutter engaging face 124. In various embodiments, the cutter mount body 128 may have a width generally similar to a width of the cutter engaging face 124 and a cutter to be held on the cutter engaging face.

Referring still to FIGS. 1 and 2, in various embodiments, the integral mount portion 120 may include a bite limiter 130. In some embodiments, the bite limiter 130 may include a flange or fin extending from the cutter mount body 128 opposite from the cutter engaging face 124 partially around the circumference of cutter holder 100. In some embodiments, the fin may extend radially from an outer surface of base 102. In various embodiments, the bite limiter 130 may extend from the cutter mount body 128 at an opposite end from the cutter engaging face 124, away from the cutter engaging face 124. In various embodiments, the bite limiter 130 may be axially narrower than the cutter mount body 128. In various embodiments, the bite limiter 130 may be axially narrower than the cutter engaging face 124. In some embodiments, the bite limiter 130 may help to control the amount of material being removed per instance of contact, which may extend the amount of time the apparatus 180 shown in FIG. 3 is in contact with material prior to decaying in RPM to a point where the driver 220 stalls when in use with the system 210 shown in FIG. 4. In various embodiments, the bite limiter 130 being axially narrower than the cutter mount body 128 may facilitate controlling the amount of material being removed or cut, without unnecessarily limiting the amount of material being removed or cut.

In various embodiments, the integral mount portion 122 may include elements generally similar to those of the integral mount portion 120.

Referring to FIGS. 1 and 2, in some embodiments, the base 102 may include convex outer surface portions, including convex outer surface portions 132 and 134, for example, disposed radially inward of the cutter mounts 110 and 112. In some embodiments, the convex outer surface portions 132 and 134 may be adjacent to a bite limiter 131, for example, but disposed radially inward of the bite limiter 131. In some embodiments, the base 102 may include additional convex outer surface portions, such as, for example, convex surface portions adjacent to the bite limiter 130, for example, but disposed radially inward of the bite limiter 130. In various embodiments, the convex outer surface portions may facilitate reduction and/or avoidance of jamming and/or overloading of the cutters when the apparatus 180 is in use. In some embodiments, the convex outer surface portions, including the convex surface portions 132 and 134, may each include a cylindrical surface portion centered on the axis of rotation 104. In various embodiments, the convex outer surface portions being cylindrical in shape around the axis of rotation 104 may facilitate ease of sliding of material thereon and/or may facilitate reduction of jamming and/or overloading of the cutters when the apparatus 180 is in use. In various embodiments, a diameter of the cylinder corresponding to the convex outer surface portions 132 and 134 may be about 4 inches.

In various embodiments, the integral mount portions 120 and 122 being integral with the base 102 may facilitate strong coupling between the first and second cutter mounts 110 and 112 and the base 102. In various embodiments, the integral mount portions 120 and 122 being integral with the base 102 may facilitate ease of manufacturing of the first cutter holder 100, such as, for example, by machining a single integral workpiece, casting, and/or forging.

In some embodiments, the integral mount portions 120 and 122 and the base 102 may be manufactured by machining a single integral workpiece of material. In some embodiments, for example, the integral mount portions 120 and 122 and the base 102 may be manufactured by milling a piece of hard strong material, such as, steel, for example. In various embodiments, this may provide more consistent results and/or reduced costs compared to fabricating the first cutter holder 100 by another method, such as, welding or assembly of parts, for example.

Referring to FIG. 3, the first cutter holder 100 is shown holding first and second cutters 240 and 242 in the first and second cutter mounts 110 and 112. In various embodiments, each of the cutter mounts 110 and 112 may be configured to releasably hold the respective cutters 240 and 242. For example, in various embodiments, each of the first and second cutters 240 and 242 may be fastened or held against a respective cutter engaging face via a respective bolt, passing through a mounting hole and threaded into the cutter. In various embodiments, releasable holding of the cutters 240 and 242 may facilitate ease of maintenance by facilitating the replacement of a cutter when the cutter is damaged or worn. In some embodiments, even though the first cutter holder 100 may be itself removable and replaceable from the apparatus 180, it may be desirable to be able to releasably hold the cutters 240 and 242 because the ability to replace the cutters while keeping the apparatus 180 assembled may reduce maintenance time and/or costs.

In some embodiments, the cutters 240 and 242 may each include a cutting tooth, such as, for example, a quad tooth, a carbide tipped single point (bullet) tooth, another tooth type, or a combination thereof. In various embodiments, each of the cutters 240 and 242 may be configured to cut or mulch plant material when held by the first cutter holder 100 and driven by the driver 220 shown in FIG. 4.

Referring to FIGS. 1 and 2, in various embodiments, the first cutter holder 100 may include a first coupler 140 (shown in FIG. 1) coupled to the base 102 and a second coupler 142 (shown in FIG. 2) coupled to the base 102, the second coupler 142 axially spaced from the first coupler 140 and configured to rotationally couple to a first coupler of a further cutter holder. For example, referring to FIG. 3, in various embodiments the second cutter holder 182 may be generally identical to the first cutter holder 100 and may include a second coupler coupled to the first coupler 140 of the first cutter holder 100. In various embodiments, the first and second couplers 140 and 142 may act as rotational mounts or connectors and/or each may include one or more protrusions for meshing with or engaging with other couplers, to rotationally couple the couplers. In various embodiments, the cutter holders including first and second couplers for rotationally coupling the cutter holders may facilitate ease of assembly and/or rotational resilience during cutting. In various embodiments, including generally identical couplers on each of the cutter holders may facilitate ease of maintenance and/or manufacturing.

Referring to FIG. 1, in some embodiments, the first coupler 140 may include first coupler faces 143, 144, 146, 148, 150, and 152, each of which extends radially from the axis of rotation 104 and is parallel to the axis of rotation. In various embodiments, the first coupler faces 143, 144, 146, 148, 150, and 152 may be generally planar and lie in a plane, which the axis of rotation 104 would also lie on. In various embodiments, the second coupler may include second coupler faces 154, 156, 158, 160, 162, and 164, each of which extends radially from the axis of rotation 104 and is parallel to the axis of rotation. In various embodiments, the second coupler faces 154, 156, 158, 160, 162, and 164 may be generally planar and lie in a plane, which the axis of rotation 104 would also lie on.

In various embodiments, the second coupler faces 154-164 of the first cutter holder 100 may be configured to engage the first coupler faces of a further cutter holder to rotationally couple to the first coupler of the further cutter holder. In various embodiments, the first coupler face 143 may engage a second coupler face corresponding to the second coupler face 162 of the further cutter holder. In various embodiments, first coupler faces 144, 146, 148, 150, and 152 may engage second coupler faces corresponding to the second coupler faces 164, 154, 156, 158, and 160 of the further cutter holder. In various embodiments, the first and second coupler faces 143-152 and 154-164 extending radially from the axis of rotation and being parallel thereto may facilitate strong engagement and reduce slipping when cutting, because forces are transferred in a direction generally normal to the faces.

In various embodiments, the first coupler 140 may include three protrusions extending axially, including first, second, and third protrusions 170, 172, and 174 shown in FIG. 1 and the second coupler 142 may include three protrusions extending axially, including first, second, and third protrusions 176, 178, and 179 shown in FIG. 2. In various embodiments, extending axially may involve extending in a direction aligned with the axis of rotation 104.

In various embodiments, the first protrusion 170 of the first coupler 140 may include the first coupler faces 143 and 152, the second protrusion 172 of the first coupler 140 may include the first coupler faces 144 and 146, and the third protrusion 174 of the first coupler 140 may include the first coupler faces 148 and 150. In various embodiments, the first protrusion 176 of the second coupler 142 may include the second coupler faces 154 and 156, the second protrusion 178 of the second coupler 142 may include the second coupler faces 158 and 160, and the third protrusion 179 of the second coupler 142 may include the first coupler faces 162 and 164.

In various embodiments, the first and second couplers 140 and 142 each including three protrusions extending axially may facilitate strong coupling and/or may facilitate use of a variety of angles when coupling first and second couplers. In various embodiments, the protrusions may facilitate removable coupling between the cutter holders, which may facilitate ease of maintenance and/or replacement of cutter holders in the apparatus 180 shown in FIG. 3. In various embodiments, the cutter holders may be decoupled by moving them apart axially.

In various embodiments, the first and second couplers 140 and 142 may be integral with the base 102. For example, in various embodiments, the protrusions 170, 172, 174, 176, 178, and 179 may be integral with the base 102. In various embodiments, the first and second couplers 140 and 142 being integral with the base 102 may facilitate strong coupling with the base 102. In various embodiments, the first and second couplers 140 and 142 being integral with the base 102 may facilitate ease of manufacturing of the first cutter holder 100, such as, for example, by machining a single integral workpiece, casting, and/or forging.

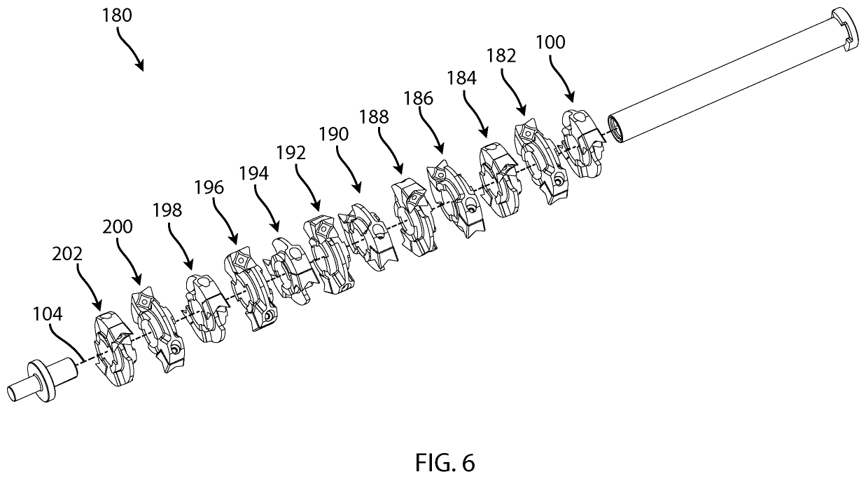

Referring to FIG. 5, the apparatus 180 of FIG. 3 is shown from a first exploded view, wherein the cutter holders 100 and 182-202 and the drive shaft 222 are shown separated along the axis of rotation 104. Referring to FIG. 6, the apparatus 180 of FIG. 3 is shown from a second exploded view, wherein the cutter holders 100 and 182-202 and the drive shaft 222 are shown separated along the axis of rotation 104.

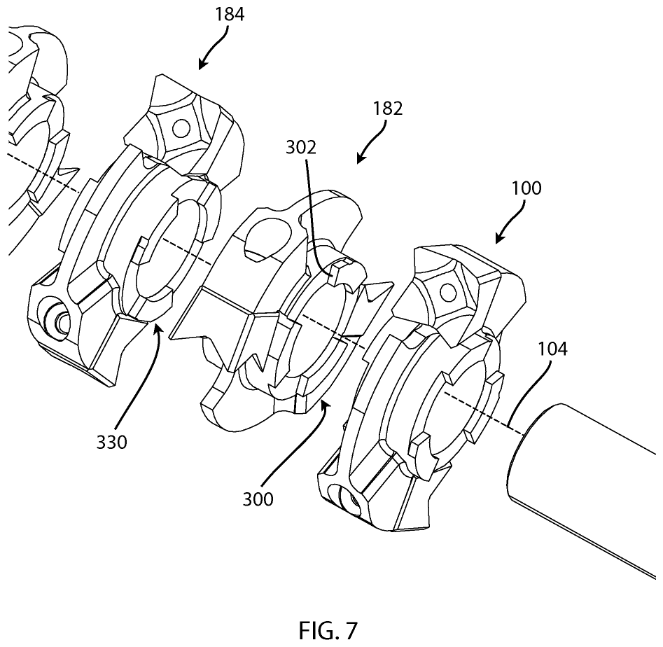

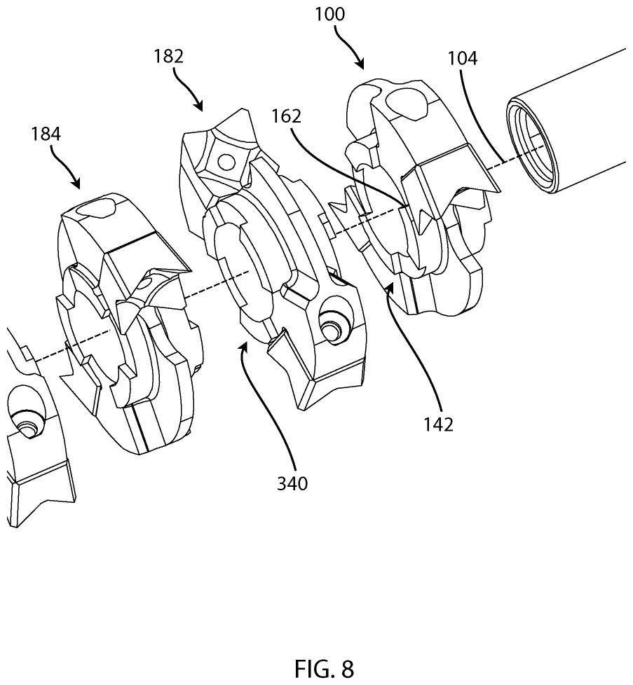

FIGS. 7 and 8 show enlarged views of the first, second, and third cutter holders 100, 182, and 184 from FIGS. 5 and 6 respectively. Referring to FIGS. 7 and 8, in various embodiments, a first coupler 300 of the second cutter holder 182 may be coupled to the second coupler 142 of the first cutter holder 100 such that the first cutter holder 100 is rotationally offset from the second cutter holder 182 by a first offset angle. In various embodiments, the offset may facilitate improved cutting of plant material during use and/or may reduce jamming of the apparatus 180 during use.

Referring to FIG. 7, in various embodiments, the second cutter holder 182 includes first coupler faces, which are generally similar to the first coupler faces 144, 146, 148, 150, 152, and 143 shown in FIG. 1, configured to abut or engage second coupler faces 164, 154, 156, 158, 160, and 162, of the first cutter holder 100. For example, in some embodiments, the second cutter holder 182 includes a first coupler face 302 (which is generally similar to the first coupler face 143 of the first cutter holder 100), which is configured to abut or engage with the second coupler face 162 (shown in FIG. 8, for example, of the first cutter holder 100 when the first and second couplers of the second and first cutter holders are engaged as shown in FIG. 3.

In some embodiments, the rotational offset between the first and second cutter holders 100 and 182 may facilitate an angular displacement between adjacent cutters on the apparatus 180, which may facilitate improved cutting performance. In some embodiments, the rotational offset may be set such that the cutters in the apparatus 180 are adjacent to bite limiters, which are not as wide (measured in the direction of the axis of rotation 104) as a cutter mount body. In various embodiments, this may facilitate improved cutting performance.

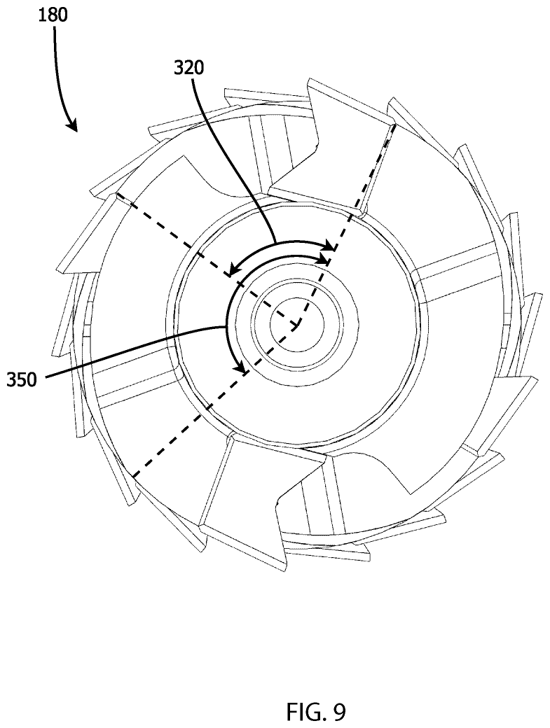

Referring to FIG. 9, the apparatus 180 is shown from an end view. In various embodiments, a first offset angle 320 between the first and second cutter holders 100 and 182 may be about 80 degrees, for example. In various embodiments, the first offset angle 320 being about 80 degrees may facilitate the cutters in the apparatus 180 being adjacent to bite limiters, which are not as wide (measured in the direction of the axis of rotation 104) as a cutter mount body. In various embodiments, this may facilitate improved cutting performance. In various embodiments, an apparatus generally similar to the apparatus 180 may use a first offset angle of about 100 degrees in the opposite direction from the first offset angle 320 between first and second cutter holders, which may similarly facilitate the cutters in the apparatus being adjacent to bite limiters. In various embodiments, the first offset angle may be near 90 degrees, such as about 10 degrees different from a 90 degree angle (i.e., 80 degrees or 100 degrees) and this may facilitate cutters in the apparatus being adjacent to bite limiters.

Referring to FIGS. 7 and 8, in various embodiments, a first coupler 330 of the third cutter holder 184 may be coupled to a second coupler 340 of the second cutter holder 182 to rotationally couple the first, second, and third cutter holders such that the first cutter holder 100 is rotationally offset from the third cutter holder 184 by a second offset angle. In various embodiments, angular displacement between cutters next to adjacent cutters on the apparatus 180 may facilitate improved cutting performance. In some embodiments, the rotational offset may be set such that the cutters that are two cutter holders apart in the apparatus 180 are slightly rotationally offset, such that they may fall on a generally helical path. In various embodiments, this may facilitate improved cutting performance.

Referring to FIG. 9, in various embodiments, the second offset angle 350 between the first and third cutter holders 100 and 184 may be about 160 degrees or equivalent to 200 degrees measured in the opposite direction, for example. In some embodiments, where the first and third cutter holders 100 and 184 each include first and second cutter mounts angularly displaced by about 180 degrees, this arrangement may facilitate angular offset between a first cutter mount of the third cutter holder 184 and the second cutter mount of the first cutter holder 100 of about 180−160=20 degrees.

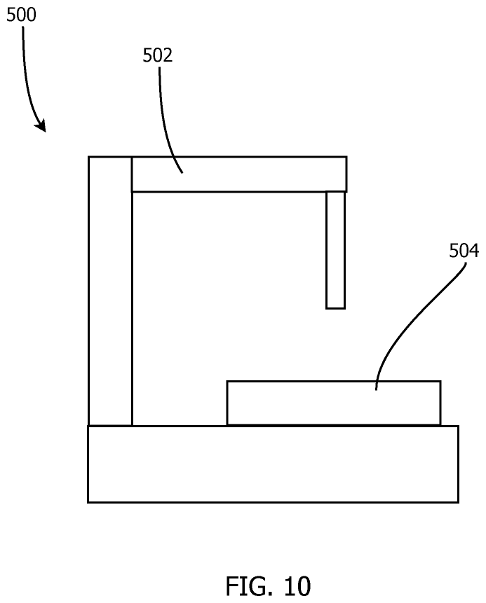

Referring to FIG. 10, there is shown a system 500 for manufacturing the first cutter holder 100 shown in FIGS. 1 and 2, in accordance with various embodiments. Referring to FIG. 10, in various embodiments, the system 500 includes a milling machine or mill 502 configured to machine a single integral workpiece 504 of material by removal of material to produce the first cutter holder 100 shown in FIGS. 1 and 2. In some embodiments, the workpiece 504 may be a hard strong material, such as, steel, for example. In various embodiments, the milling machine 502 may include a vertical milling machine as shown in FIG. 10. In some embodiments, the milling machine 502 may include a horizontal milling machine. In various embodiments, the milling machine 502 may include a computer numerical control (CNC) milling machine configured to take as an input, a model, representing the first cutter holder 100 and to machine the workpiece 504 by removal of material to produce the first cutter holder 100 shown in FIGS. 1 and 2. In some embodiments, such manufacturing of the first cutter holder 100 by machining the workpiece 504 by removal of material may provide more consistent results and/or reduced costs compared to fabricating the first cutter holder 100 by some other methods, such as, welding or assembly of parts, for example.

In various embodiments, the milling machine 502 may manufacture the first cutter holder 100 by machining the workpiece 504 by removal of material. In some embodiments, the milling machine 502 or one generally similar thereto may similarly manufacture the cutter holders 182-202 shown in FIGS. 3, 5 and 6. In some embodiments, some features of the cutter holders, such as, for example, the mounting hole for the cutter mount may be cut using another machine, such as, for example, using a horizontal mill, because of the individual machine capabilities. In various embodiments, the apparatus 180 may be assembled by sliding each of the cutter holders 100 and 182-202 over the drive shaft 222 shown in FIG. 5. In various embodiments, the drive shaft 222 may include a coupler 224 shown in FIG. 5, shaped generally similarly to the second coupler 142 of the first cutter holder 100 shown in FIGS. 1 and 2. In various embodiments, the first coupler 140 of the first cutter holder 100 may rotationally couple to the coupler 224 of the drive shaft 222 to rotationally lock the first cutter holder 100 and thereby rotationally lock the cutter holders 182-202 with the drive shaft 222.

In various embodiments, machining the cutter holder from a single integral workpiece may facilitate avoidance or reduction of fabrication and/or welding, which may otherwise need to be done manually using a manual fabricator and/or a robotic welding system, for example. In some embodiments, machining out of one piece may facilitate consistency, automation and/or lights out production, which may reduce costs for manufacturing labour.

In some embodiments, a method of manufacturing the first cutter holder 100 shown in FIGS. 1 and 2 may involve casting the first cutter holder. In some embodiments, there may be provided a mold including walls defining a cavity having a shape corresponding to the first cutter holder 100 shown in FIGS. 1 and 2. In various embodiments, a method of manufacturing the first cutter holder 100 may involve pouring liquid metal into the mold to cast the first cutter holder 100.

In some embodiments, a method of manufacturing the first cutter holder 100 shown in FIGS. 1 and 2 may involve forging the first cutter holder 100 from a single integral workpiece of material.

In various embodiments, casting and/or forging the cutter holder to form a single integral cutter holder may facilitate avoidance or reduction of fabrication and/or welding, which may otherwise need to be done manually using a manual fabricator and/or a robotic welding system, for example. In some embodiments, casting and/or forging into one piece may facilitate consistency, automation and/or lights out production, which may reduce costs for manufacturing labour.

In some embodiments, a combination of techniques may be employed to manufacture the first cutter holder 100. For example, in some embodiments, a method of manufacturing the first cutter holder 100 may involve casting and/or forging a base material, which may be used as a workpiece for subsequent machining, which may be required for manufacturing of the first cutter holder 100.

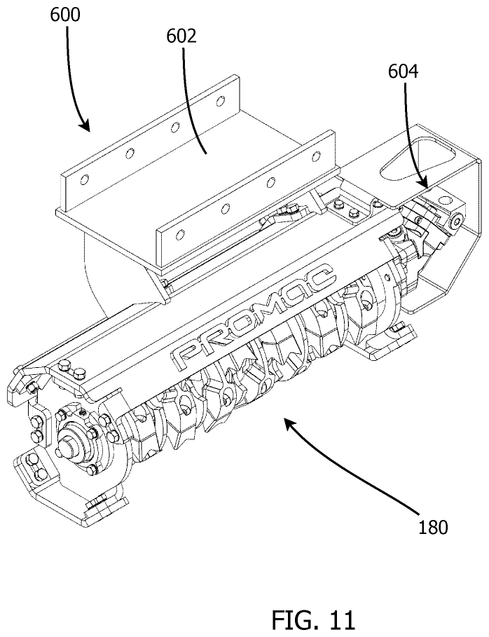

Referring to FIG. 11, in various embodiments, in operation, the apparatus 180 may be included in a boom mountable system 600 shown in FIG. 11. Referring to FIG. 11, in various embodiments, the boom mountable system 600 includes a boom mount 602 for mounting to a boom of a driver, such as the driver 220 shown in FIG. 4 and a drive shaft coupler 604 configured to provide rotational drive to the drive shaft 222 of the apparatus 180 shown in FIG. 3. In various embodiments, in operation, an operator of the driver 220 may cause a hydraulic system of the driver 220 to drive the drive shaft coupler 604 to cause the drive shaft 222 to rotate and thereby cause the apparatus 180 to rotate. For example, in some embodiments, the drive shaft may rotate at about 2000 RPM. In various embodiments, while the cutters of the apparatus 180 are rotating, the operator of the driver 220 may move the apparatus 180 into engagement with plant material, for cutting and/or mulching the material.

In various embodiments, if a cutter of the apparatus 180 is damaged during use, the cutter may be removed from the cutter holder upon which it is mounted and replaced or repaired. In some embodiments, if one of the cutter holders of the apparatus 180 is damaged during use, then the damaged cutter holder may be removed and replaced or repaired.

While FIG. 4 shows an excavator acting as the driver 220, in various embodiments another driver may be used, such as, for example, a tractor, a skidsteer, or another host carrier configured to move and drive the apparatus 180.

While the apparatus 180 shown in FIGS. 3-9 includes 12 cutter holders, in various embodiments an apparatus configured to function generally similarly to the apparatus 180 may include additional or fewer cutter holders.

While the first cutter holder 100 shown in FIGS. 1 and 2 includes two cutter mounts, in various embodiments, a cutter holder configured to function generally similarly to the first cutter holder 100 may include additional or fewer cutter mounts.

In various embodiments, first and second elements being integral with one another may mean that the first and second elements are made from the same material and that there are no gaps between the first and second elements. For example, in some embodiments, elements that are welded together may not be considered integral, for example, because although a perimeter of the elements may be bonded, there may be a gap between the elements that is not considered bonded. In various embodiments, being integral with one another may be reached by milling the elements from a single block of material, from forging the elements together, and/or from casting the elements together, for example.

While specific embodiments of the present disclosure have been described and illustrated, such embodiments should be considered illustrative of the present disclosure only and not as limiting the present disclosure as construed in accordance with the accompanying claims.

1. A cutter holder for facilitating plant material cutting, the cutter holder comprising:
a base configured to rotationally couple to a driver and to rotate about an axis of rotation of the base during operation;
one or more cutter mounts coupled to the base, each of the one or more cutter mounts configured to hold a respective cutter and to facilitate cutting of plant material by the cutter when the cutter is held and the base is rotated about the axis of rotation by the driver;
a first coupler coupled to the base; and
a second coupler coupled to the base, the second coupler axially spaced from the first coupler and configured to rotationally couple to a first coupler of a further cutter holder.

2. The cutter holder of claim 1 wherein each of the one or more cutter mounts includes an integral mount portion integral with the base and disposed radially outward from the base.

3. The cutter holder of claim 2 wherein the integral mount portion of each of the one or more cutter mounts includes a cutter engaging face configured to abut a cutter when the cutter is held by the cutter mount, the cutter engaging face generally perpendicular to a direction of travel of the cutter engaging face when the base is rotated about the axis of rotation.

4. The cutter holder of claim 2 or 3 wherein the integral mount portion of each of the one or more cutter mounts includes a bite limiter.

5. The cutter holder of claim 4 wherein the integral mount portion includes a cutter mount body, the bite limiter extending from the cutter mount body and axially narrower than the cutter mount body.

6. The cutter holder of any one of claims 1 to 5 wherein the first and second couplers are integral with the base.

7. The cutter holder of any one of claims 1 to 6 wherein the base includes a ring configured to engage and encircle a drive shaft configured to be driven by the driver.

8. The cutter holder of any one of claims 1 to 7 wherein the base includes at least one convex outer surface portion disposed radially inward of the one or more cutter mounts.

9. The cutter holder of claim 8 wherein the at least one convex outer surface portion includes one or more cylindrical surface portions centered on the axis of rotation.

10. The cutter holder of any one of claims 1 to 9 wherein the one or more cutter mounts include a plurality of cutter mounts each of the plurality of cutter mounts configured to hold a respective cutter.

11. The cutter holder of claim 10 wherein the one or more cutter mounts include a first cutter mount and a second cutter mount, the second cutter mount angularly displaced from the first cutter mount by about 180 degrees about the axis of rotation.

12. The cutter holder of any one of claims 1 to 11 wherein the second coupler is configured to removably couple to the first coupler of the further cutter holder.

13. The cutter holder of any one of claims 1 to 12 wherein the first coupler includes at least one first coupler face that extends radially from and parallel to the axis of rotation and the second coupler includes at least one second coupler face that extends radially from and parallel to the axis of rotation such that at least one second coupler face is configured to engage at least one first coupling face of the further cutter holder to rotationally couple to the first coupler of the further cutter holder.

14. The cutter holder of any one of claims 1 to 13 wherein the first coupler includes three protrusions extending axially and the second coupler includes three protrusions extending axially.

15. The cutter holder of any one of claims 1 to 14 wherein each of the one or more cutter mounts is configured to releasably hold the respective cutter.

16. An apparatus for facilitating plant material cutting, the apparatus comprising:
a first cutter holder according to any one of claims 1 to 15;
a second cutter holder according any one of claims 1 to 15, the first coupler of the second cutter holder coupled to the second coupler of the first cutter holder to rotationally couple the first and second cutter holders.

17. The apparatus of claim 16 wherein the first coupler of the second cutter holder is coupled to the second coupler of the first cutter holder such that the first cutter holder is rotationally offset from the second cutter holder by a first offset angle.

18. The apparatus of claim 16 or 17 further comprising a third cutter holder according to any one of claims 1 to 15, the first coupler of the third cutter holder coupled to the second coupler of the second cutter holder to rotationally couple the first, second, and third cutter holders such that the first cutter holder is rotationally offset from the third cutter holder by a second offset angle.

19. A system for facilitating plant material cutting, the system comprising the apparatus of any one of claims 16 to 18 and a plurality of cutters, each of the cutter mounts of the cutter holders of the apparatus holding a respective one of the plurality of cutters.

20. The system of claim 19 further comprising a driver coupled to the bases of the cutter holders of the apparatus, the driver configured to rotate the cutter holders and the plurality of cutters to cause the cutters to cut plant material.

21. A method of manufacturing a cutter holder for facilitating plant material cutting, the method comprising machining a single integral workpiece of material by removal of material to produce the cutter holder of any one of claims 1 to 15.

22. A system for manufacturing a cutter holder for facilitating plant material cutting, the system comprising a milling machine configured to perform the method of claim 21.

23. A method of manufacturing a cutter holder for facilitating plant material cutting, the method comprising casting the cutter holder of any one of claims 1 to 15.

24. A method of manufacturing a cutter holder for facilitating plant material cutting, the method comprising forging the cutter holder of any one of claims 1 to 15 from a single integral workpiece of material.
